(19) United States
(12) Patent Application Publication
(10) Pub. No.: US 2026/0199933 A1
(43) Pub. Date: Jul. 16, 2026

(54) DISPENSER

(71) Applicant: medmix Switzerland AG, Haag (Rheintal) (CH)

(72) Inventors: Mark TINKLER, Thatcham (GB); Nick FITTON, Swindon (GB); Stephen DONLON, Brentford (GB); Matt LYNDON, Chandlers Ford (GB)

(21) Appl. No.: 19/131,192

(22) PCT Filed: Nov. 29, 2023
(86) PCT No.: PCT/EP2023/083487

§ 371 Date: May 19, 2025

(30) Foreign Application Priority Data
Nov. 29, 2022 (GB) 2217922.0

(51) Int. Cl. B05C 17/01; B05C 17/005; B65D 83/763; B65D 83/766

(52) U.S. Cl. CPC B05C 17/0136; B05C 17/00596; B65D 83/763; B65D 83/766

(57) ABSTRACT

A dispenser for dispensing viscous and non-viscous materials includes a frame, a material storage positioned within the frame and containing at least one material to be dispensed, and a dispensing mechanism for acting on a piston for dispensing the material from the material storage. The dispensing mechanism includes a driving unit to generate driving energy for causing the dispensing movement of the piston, and an energy buffer to absorb a portion of the energy generated by the driving unit during the dispensing movement of the piston. The energy buffer outputs the absorbed energy over a longer period of time than the driving unit is operated to move the piston.

### CROSS-REFERENCE TO RELATED APPLICATION

This application is a U.S. national stage application of International Application No. PCT/EP2023/083487, filed on Nov. 29, 2023, which claims priority to GB Application No. 2217922.0, filed on Nov. 29, 2022, the contents of each of which are hereby incorporated by reference.

### BACKGROUND

### Technical Field

The present disclosure relates to a dispenser for dispensing viscous and non-viscous materials.

### Background Information

FIG. 1 shows a cross-sectional view of an exemplary dispenser 100 with an in principle known basic functionality. The dispenser 100 comprises a dispenser handle 1 to which a trigger 2 is coupled pivotably. A driving rod 3 is in engagement with a spring-loaded driving unit 4 with a catch plate. The dispenser 100 comprises a frame 5 fixed to the dispenser handle 1 and configured to support a support sleeve 6.

A spray valve 8 with a nozzle 9 forming a manually operable valve assembly is connectable to a proximal end of a flexible pouch 10 within the support sleeve 6. The flexible pouch 10 serves as material storage for at least one material to be dispensed.

To dispense the material from the flexible pouch 10 a piston 11 is provided on a distal side of the flexible pouch 10 axially movable along the support sleeve 6. The piston 11 is shaped to match the front portion of the flexible pouch 10 to minimize residual material within the flexible pouch 10 after a full dispensing stroke with the piston 11.

A plunger 12 is fixed to the driving rod 3 of the dispenser 100 and configured to transfer an axial movement of the driving rod 3 caused by an operation of the trigger 2, onto the piston 11 to squeeze the flexible pouch 10 for dispensing the material from the flexible pouch 10. Furthermore, a lock and release mechanism 30 is provided operatively between the dispenser handle 1 and the driving rod 3 to lock the driving rod 3 axially with respect to the dispenser handle 1 in a releasable manner, when the trigger 2 is released. As the structural and functional configuration of the various above described components is well known to a skilled artisan, a detailed description thereof is omitted for the sake of brevity.

### SUMMARY

In such a system, propulsion energy and/or force is generated only when the trigger 2 is operated and not when the trigger 2 returns to its initial orientation. It has been determined that this results in a pulsating dispensing process which is difficult to control.

In view of this, a problem to be solved by the present disclosure is to provide a dispenser not suffering from such negative effects.

This problem is solved by a dispenser in accordance with the present disclosure. Preferable modifications for such a dispenser can be taken from the herein described embodiments.

According to the present disclosure, a dispenser for dispensing viscous and non-viscous materials comprises a frame, a material storage positioned within the frame and containing at least one material to be dispensed, as well as a dispensing mechanism for acting on a for dispensing the material from the material storage. The dispensing mechanism comprises a driving unit configured to generate driving energy for causing the dispensing movement of the piston, and an energy buffer configured to absorb a portion of the energy generated by the driving unit during the dispensing movement of the piston. The energy buffer is configured to output the absorbed energy over a longer period of time than the driving unit is operated to move the piston.

This configuration allows charging the energy buffer during the dispensing movement of the piston and to increase the time of dispensing the material from the material storage exceeding the operation time of the driving unit. Thus, the energy generated by the driving unit can be output in a very homogeneous and gentle manner for driving the piston and dispensing the material from the material storage in a highly controlled manner.

Preferably, the driving unit is configured to be driven manually.

Such a configuration can be operated in an easy manner without the necessity of providing a separate external energy source.

Preferably, the material storage is replaceably mounted within the frame.

Thus, a multiple-use dispenser for dispensing viscous and non-viscous material from various material storages is formed.

Preferably, the material storage comprises only one container filled with only one material.

Such a configuration is structurally very simple and, thus, robust.

Preferably, the material storage comprises at least one flexible container or pouch for the at least one material to be dispensed.

A flexible container or pouch allows a very resource-efficient and lightweight configuration easy to handle. Alternatively, the material storage can comprise at least one rigid container or cartridge for the at least one material to be dispensed, resulting in a very robust overall configuration.

Further preferably, the dispenser comprises a rigid support sleeve surrounding the at least one flexible container or pouch.

Such a configuration results in a very robust configuration.

Further preferably, the support sleeve comprises a trumpet feature for receiving the piston.

Thus, a very smooth and power-saving introduction of the piston into the support sleeve is enabled.

Preferably, the dispenser is a handheld device. In particular, the dispenser has a pistol-like overall shape.

Such a dispenser is very easy to handle by a user.

Preferably, the dispenser comprises a driving rod configured to be moved for loading the energy buffer. The piston is configured to be moved by the energy from the energy buffer for dispensing the material from the material storage.

Thus, all the energy generated by the driving unit is introduced into the energy buffer before acting on the piston. Such a configuration is very compact and reliable.

Further preferably, the energy buffer is positioned between the driving rod and the piston. In particular the driving rod is connected to a plunger and the energy buffer is positioned between the plunger and the piston.

This implementation is very robust and functional.

Alternatively, the piston can be fixedly connected to or integrated into the driving rod.

This implementation is very compact and reliable.

Preferably, the energy buffer is of mechanical type.

Such a configuration is very robust and reliable

Preferably, the energy buffer is formed of an elastically deformable material or of an elastically deformable composite of materials.

Thus, a very functional and reliable configuration is formed.

Preferably, the energy buffer is a spring.

This configuration is very simple and robust.

Preferably, the energy buffer comprises a sprung frame also acting as force limiter configured to limit and/or regulate the force applied by the driving unit.

Such a configuration is very compact and highly functional.

### BRIEF DESCRIPTION OF THE DRAWINGS

Exemplary embodiments and functions of the present disclosure are described herein in conjunction with the drawings, wherein:

FIG. 1 shows a cross-sectional view of an exemplary dispenser with an in principle known basic functionality;

FIG. 2 shows a partial perspective view of a dispenser in accordance with a first embodiment of the present disclosure;

FIG. 3 shows a partial cross-sectional view of the dispenser of FIG. 2;

FIG. 4 shows a partial cross-sectional view of a dispenser in accordance with a second embodiment of the present disclosure;

FIG. 5 shows a partial cross-sectional view of a dispenser in accordance with a third embodiment of the present disclosure;

FIG. 6 shows a perspective view of a dispenser in accordance with a fourth embodiment of the present disclosure;

FIG. 7 shows a perspective view of an alternative implementation of the basic concept of the dispenser of FIG. 6; and

FIG. 8 shows a perspective view of an exemplary valve assembly used with the dispenser of FIG. 7.

### DETAILED DESCRIPTION

In the present document, the term “distal” refers to the part/end of the device, or the parts/ends of the components or members thereof, which in accordance with the use of the device, is/are located the furthest away from a delivery/injection site. Correspondingly, the term “proximal” refers to the part/end of the device, or the parts/ends of the members thereof, which in accordance with the use of the device is/are located closest to the delivery/injection site.

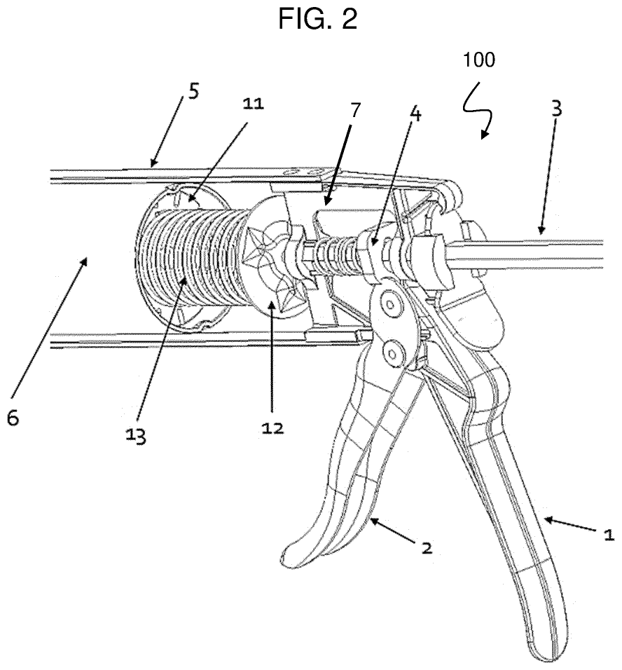

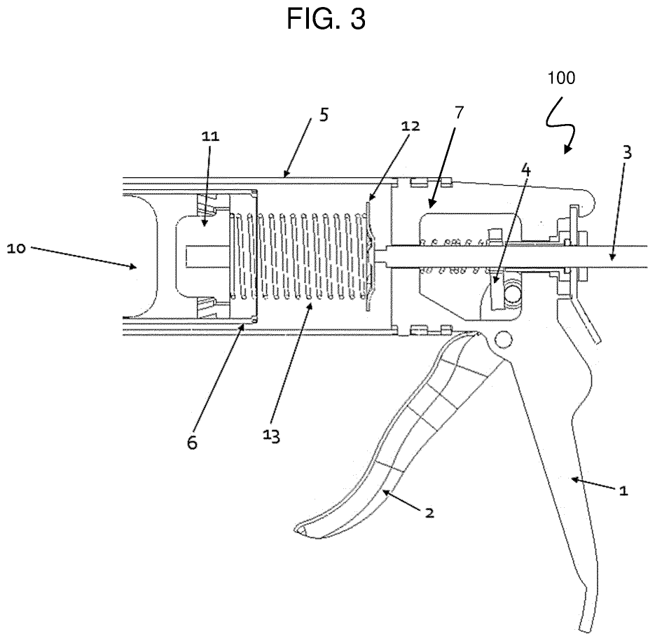

As it is illustrated in FIGS. 2 and 3, a dispenser 100 in accordance with a first exemplary embodiment differs from the above described configuration purely by a further provided energy buffer 13 in the form of a compressible spring. The energy buffer 13 is located between the plunger 12 and the piston 11. In other words, the dispenser 100 comprises a dispensing mechanism 7 for acting on the piston 11 comprising a driving unit 4 and the energy buffer 13.

The energy buffer 13 is configured to divide driving energy received from the driving unit 4 into a first part transferred directly onto the piston 11 and a second part stored within the energy buffer 13, in particular in the form of deformation energy. Thus, some of the driving energy from the driving unit 4 is absorbed by the energy buffer 13 while the remaining driving energy is transferred onto the piston 11. This results in an axial movement of the piston 11 upon operation of the driving unit 4 but prevents an erratic force transmission onto the flexible pouch 10.

The energy buffer 13 is configured to output the absorbed energy, at least partly, over a longer period of time, than the driving unit 4 is operated to move the piston 11. In other words, even when a user stops operating the driving unit 4 for generate new driving energy, the energy buffer 13 is active and transfers energy to the piston 11, stored within the energy buffer 13 during the operation of the driving unit 4. This allows a user to load the energy buffer 13 with several strokes of the trigger 2 for dispensing material from the flexible pouch 10 for some time without the need of further operating the driving unit 4.

In the illustrated embodiment, the energy buffer 13 is provided in the form of a compressible metal coil spring. However, also other materials or structural implementations for the energy buffer 13 are possible. For example, the energy buffer 13 could be formed by a plastic spring, a compressible bellow filled with compressible gas or by a closed-cell plastic foam element. Furthermore, the energy buffer 13 can be formed not as component separate from the piston 11 and the plunger 12 but as compressible part moulded onto the piston 11 or the plunger 12. Accordingly, the type of the energy buffer 13 can be hydraulic, pneumatic and/or mechanical. Also, any combination of these types and combinations of separate components to form the energy buffer 13 is/are possible.

Independently of the specific implementation of the energy buffer 13, it is essential to the basic idea of the present disclosure that the energy buffer 13 is not configured as energy storage loaded by an operation of the driving unit 4 and activated separately from the operation of the driving unit 4 to output the stored energy. Rather, the energy buffer 13 is loaded directly during the dispensing movement and outputs its energy directly after the operation of the driving unit 4.

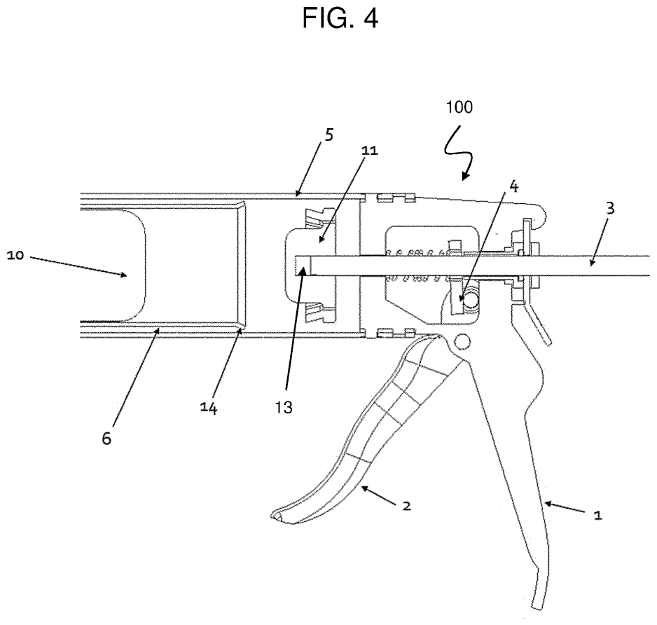

FIG. 4 shows a further exemplary embodiment of a dispenser 100 in accordance with the present disclosure. In this configuration, no plunger 12 is fixed to the driving rod 3 but the piston 11 is directly coupled to the driving rod 3. In such a configuration, is it preferable to provide the distal end of the support sleeve 6 with a trumpet feature 14 to allow the easy insertion of the piston 11.

The energy buffer 13 can be formed as part of the piston 11 itself or as an additional component or section between the piston 11 and the driving rod 3. In particular, a closed pressure chamber 13 can be formed within the piston 11. In this pressure chamber 13 compressible material like air is provided to serve as energy buffer 13 in the sense of the present disclosure.

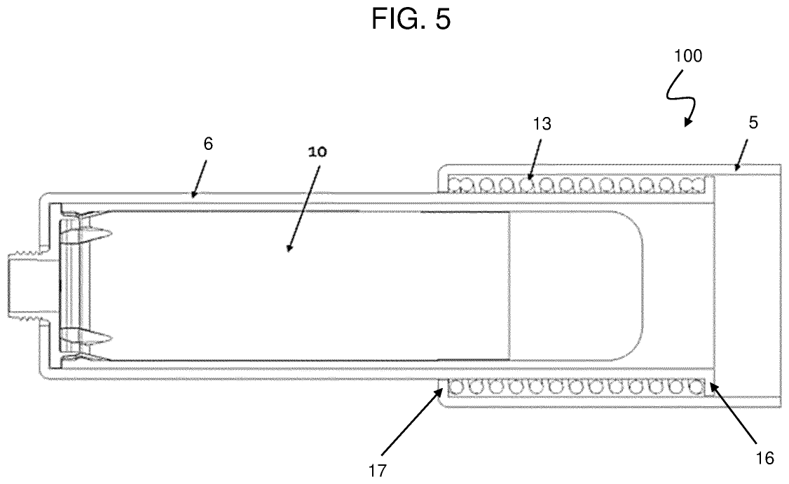

As illustrated for example in FIG. 5, the energy buffer 13 can also be not provided in a direct force-transmission path between the driving unit 4 and the piston 11. For example, the support sleeve 6 can be coupled to the frame 5 in a manner to be movable proximally with respect to the frame 5 against an energy buffer 13. Here, the energy buffer 13 is provided in the form of a helical pressure spring clamped between radial protrusions 16 and 17 of the support sleeve 6 and the frame 5. Thus, a part of the driving energy transferred onto the piston 11 is absorbed via an axial relative movement of the support sleeve 6 with respect to the frame 5 within the energy buffer 13, to be output at least partly after the operation of the driving unit 4 was stopped.

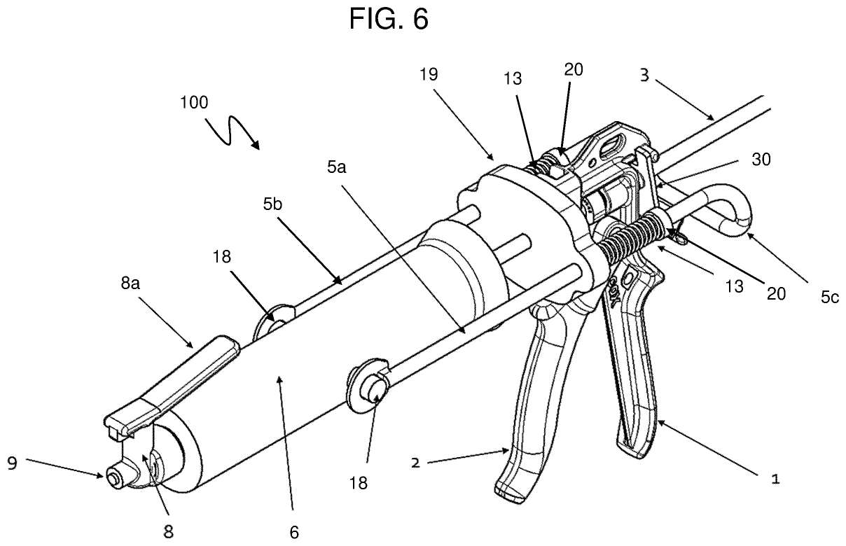

Finally, it is referred to a preferred fourth exemplary embodiment with respect to FIG. 6.

Here, the dispenser 100 comprises a support sleeve 6, in particular similar to the support sleeve described above with reference to FIG. 4, coupled axially fixed but rotatably about corresponding pin members 18 to proximal ends of two arms 5a and 5b of a frame 5. Thus, the dispenser 100 is configured to be “rear loaded”. For loading the dispenser 100 with the flexible pouch 10, the support sleeve 6 is rotated out from the horizontal orientation of FIG. 6 for inserting the flexible pouch 10 into the support sleeve 6. Afterwards, the support sleeve 6 is rotated back into the horizontal orientation of FIG. 6, such that the piston 11 can be moved into the support sleeve 6.

The arms 5a and 5b of the frame 5 are connected to each other at their distal ends via a bracket 5c. For guiding an axial movement of the frame components 5a to 5c with respect to the dispenser handle 1, a guiding plate 19 comprising three through holes, one for each of the two arms 5a and 5b and one for the driving rod 3, is fixedly coupled to the dispenser handle 1 either directly or via further intermediate components. Each of the two arms 5a and 5b is provided with a collar 20 between the guiding plate 19 and the bracket 5c. Between each of these two collars 20 and the guiding plate 19, an energy buffer 13 in the form of a coil spring is clamped. Thus, a “sprung frame” acting both as force limiter and as energy buffer in the sense of the present disclosure is formed.

In the following, the function of such a dispenser 100 is described:

A proximal movement of the driving rod 3 caused by the driving unit 4 results in response to a mechanical resistance within the support sleeve 6 (partly from frictional forces and partly from an increasing pressure within the flexible pouch 10) in a proximal movement of the support sleeve 6 and, thus, of the two arms 5a and 5b with their collars 20 with respect to the guiding plate 19. This axial movement results in a compression of the coil springs serving as energy buffer 13 in the sense of the present disclosure.

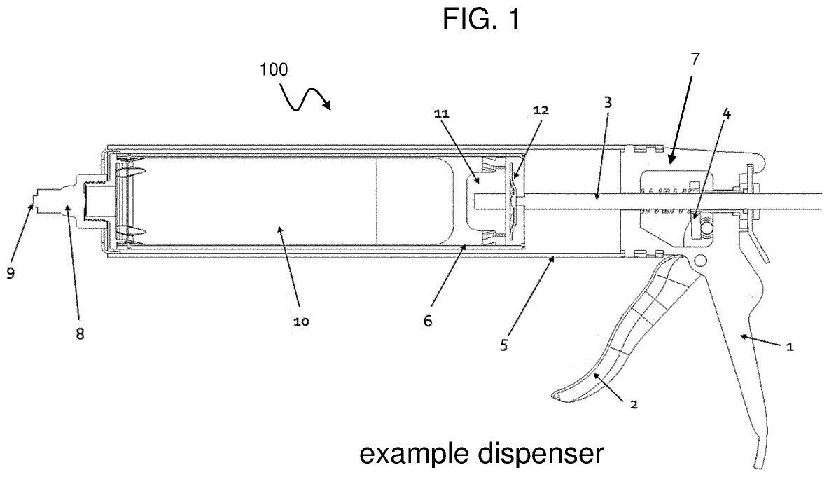

When the axial movement of the arms 5a and 5b with respect to the guiding plate 19 and, thus, with respect to the dispenser handle 1 exceeds a predetermined amount, the bracket 5c operates a lock and release mechanism 30 to the driving rod 3 (similar to the lock and release mechanism of FIG. 1). This releases the energy still present in the dispenser 100.

With this configuration, the maximum amount of energy stored within the energy buffer 13 and, thus, also the maximum amount of force acting onto the flexible pouch 10 within the support sleeve 6 is limited.

To control the dispensing process with the dispenser 100 more accurately, a valve assembly with a spray valve 8 having an operation handle 8a for manually closing and opening the spray valve 8, and a nozzle 9 can be coupled to a proximal outlet opening of the material storage 10.

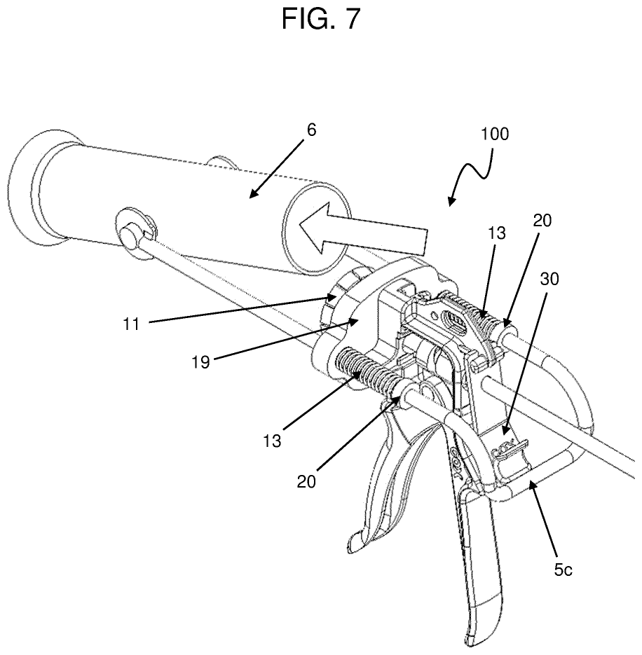

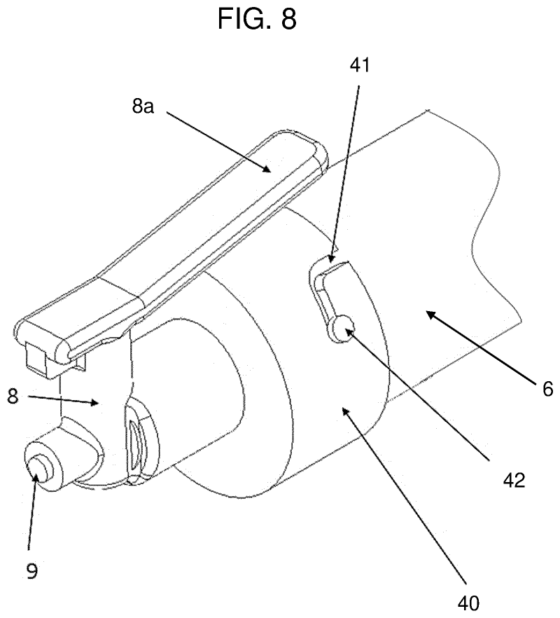

The valve assembly 8, 9 can be coupled, in particular in rear-loaded configurations, directly to the material storage 10, for example via a threaded connection (see FIG. 6 in view of FIG. 5). Alternatively, the valve assembly 8, 9 can be coupled, in particular in front-loaded configurations, to the support sleeve 6. FIG. 7 shows a front-loaded implementation of the “sprung-frame” configuration of FIG. 6 in the loading state (indicated by the arrow). In such a configuration, the valve assembly 8, 9 can be provided with a cap portion 40 releasably coupled via a bayonet guide 41 and a bayonet pin 42 to the support sleeve 6, as it is illustrated in FIG. 8. However, also other types of connections cab be implemented.

It is pointed to the fact that the finally achieved scope of protection is defined by the appending claims and covers also modifications and/or combinations of the above described exemplary embodiments.

In this context, it is pointed to the following additional features and modifications:

The present disclosure refers to a dispenser 100 for dispensing viscous and non-viscous materials. The dispenser 100 comprises a frame 5, a material storage 10 positioned within the frame 5 and containing at least one material to be dispensed, as well as a dispensing mechanism 7 for acting on a piston 11 for dispensing the material from the material storage 10. The dispensing mechanism 7 comprises a driving unit 4 configured to generate driving energy for causing the dispensing movement of the piston 11, and an energy buffer 13 configured to absorb a portion of the energy generated by the driving unit 4 during the dispensing movement of the piston 11. The energy buffer 13 is configured to output the absorbed energy over a longer period of time than the driving unit 4 is operated to move the piston 11.

The driving unit 4 can be configured to be driven manually.

The driving unit 4 can comprise a motor

The driving unit 4 can comprise an internal energy source for energizing the motor.

The motor of the driving unit 4 can be configured to be supplied with electrical energy from an external source.

The motor of the driving unit 4 can be configured to be supplied with low voltage or mains voltage.

The material storage 10 can be fixedly mounted within the frame 5.

The material storage 10 can be replaceably mounted within the frame 5.

The at least one material within the material storage 10 can be of low viscosity. In particular the at least one material can be a liquid.

The material storage 10 can comprise only one container filled with only one material.

The material storage 10 can comprise at least two separate containers filled with different materials to be dispensed in a specific mixing ratio.

The material storage 10 can comprise at least one flexible container or pouch for the at least one material to be dispensed.

The dispenser 100 can comprise a rigid support sleeve 6 surrounding the at least one flexible container or pouch.

The support sleeve 6 can comprise a trumpet feature 14 for receiving the piston 11.

The material storage 10 can hold 100 ml to 10 l, in particular 600 ml, of the material(s) to be dispensed.

The dispenser 100 can be a handheld device.

The dispenser 100 can have a pistol-like overall shape.

The dispenser 100 can be a body-mounted device, in particular carried via a belt clip, a should strap or a back pack.

The dispenser 100 can be an on-floor device, in particular sitting directly on the floor, provided with wheels or provided with legs, in particular configured to span the ridges of corrugated roofs.

The dispenser 100 can be a wall-mounted device.

The material storage 10 can comprise an outlet opening for dispensing the material therefrom. The outlet opening can be provided with a manually operable valve assembly 8, 9 for controlling the dispensing of the material through the outlet opening.

The valve assembly 8, 9 can end in a nozzle 9 for dispensing the material.

The dispenser 100 can comprise a driving rod 3 configured to be moved for loading the energy buffer 13. The piston 11 can be configured to be moved by the energy from the energy buffer 13 for dispensing the material from the material storage 10.

The energy buffer 13 can be position between the driving rod 3 and the piston 11.

The driving rod 3 can be connected to a plunger 12 and the energy buffer 13 can be positioned between the plunger 13 and the piston 11.

The piston 11 can be fixedly connected to or integrated into the driving rod 3.

The piston 11 can be a component separate from the driving rod 3.

The energy buffer 13 can be integrated into the driving rod 3.

The energy buffer 13 can be integrated into the piston 11.

The energy buffer 13 can be of mechanical type.

The energy buffer 13 can be formed of an elastically deformable material.

The energy buffer 13 can be formed of an elastically deformable composite of materials.

The energy buffer 13 can be a spring.

The energy buffer 13 can be moulded.

The energy buffer 13 can be of hydraulic type.

The energy buffer 13 can be of pneumatic type.

The driving unit 4 can comprise an air pump.

The driving unit 4 can comprise a bicycle style pump.

The driving unit 4 can comprise a positive displacement pump.

The driving unit 4 can comprise an electric compressor.

The driving unit 4 can comprise a central compressed air system.

The driving unit 4 can comprise air bottles.

The dispenser 100 can be formed of two separate bodies connected to each other via a hose or flexible tube.

The first body of the dispenser 100 can comprise the material storage provided within a pressure tube, and the second body of the dispenser can comprise a pressure source.

The hose or flexible tube can comprise a valve with a connector allowing to decouple the first body from the second body.

The energy buffer 13 can comprise compressed air stored in the pressure tube of the first body allowing the dispensing of the material after decoupling the first body from the second body.

The two bodies of the dispenser 100 can be connected to each other via telescopically coupled rods allowing an extension and retraction of the overall dispenser 100 along an axial direction thereof.

The dispenser 100 can comprise a hand-held sprayer connected to an outlet opening of the material storage 10 for dispensing the material.

The hand-held sprayer can comprise a valve assembly 8, 9 and a manually operable control interface 8a, in particular a lever or knob, for controlling the dispense operation.

The energy buffer 13 can be formed by a combination of a pneumatic or hydraulic energy buffer and a mechanical storage.

The energy buffer 13 can be, at least partly, formed by an enclosed volume of fluid, in particular of air.

The energy buffer 13 can comprise further a mechanical energy buffer, in particular with a mechanical spring.

The further mechanical energy buffer can act between two bodies of the dispenser 100 movable relative to each other with an increasing amount of hydraulically or pneumatically stored energy within the fluid.

The dispenser 100 can be configured such that a valve assembly with a spray valve 8 operable via an operation handle 8a, and a nozzle 8 can be coupled, for example via a threaded connection or via a bayonet connection, to the material storage 10 or to the support sleeve 6.

The energy buffer 13 can comprise a sprung frame 5 also acting as force limiter configured to limit and/or regulate the force applied by the driving unit 4.

1. A dispenser for dispensing viscous and non-viscous materials, comprising:
a frame;
a material storage positioned within the frame and containing at least one material to be dispensed; and
a dispensing mechanism configured to act on a piston to dispense the material from the material storage,
the dispensing mechanism comprising a driving unit configured to generate driving energy to cause a dispensing movement of the piston, and an energy buffer configured to absorb a portion of the energy generated by the driving unit during the dispensing movement of the piston,
the energy buffer is configured to output the absorbed energy over a longer period of time than the driving unit is operated to move the piston.

2. The dispenser of claim 1,
wherein the driving unit is configured to be driven manually.

3. The dispenser of claim 1,
wherein the material storage is replaceably mounted within the frame.

4. The dispenser of claim 1,
wherein the material storage comprises only one container filled with only one material.

5. The dispenser of claim 1,
wherein the material storage comprises at least one flexible container or pouch for the at least one material to be dispensed.

6. The dispenser of claim 5,
wherein the dispenser comprises a rigid support sleeve surrounding the at least one flexible container or pouch.

7. The dispenser of claim 6,
wherein the support sleeve comprises a trumpet feature to receive the piston.

8. The dispenser of claim 1,
wherein the dispenser is a handheld device, and
the dispenser has a pistol-like overall shape.

9. The dispenser of claim 1,
wherein the dispenser comprises a driving rod configured to be moved to load the energy buffer, and
the piston is configured to be moved by the energy from the energy buffer to dispense the material from the material storage.

10. The dispenser of claim 9,
wherein the energy buffer is positioned between the driving rod and the piston, and
the driving rod is connected to a plunger and the energy buffer is positioned between the plunger and the piston.

11. The dispenser of claim 9,
wherein the piston is fixedly connected to or integrated into the driving rod.

12. The dispenser of claim 1,
wherein the energy buffer is of a mechanical type.

13. The dispenser of claim 1,
wherein the energy buffer is formed of an elastically deformable material or of an elastically deformable composite of materials.

14. The dispenser of claim 1,
wherein the energy buffer is a spring.

15. The dispenser of claim 1,
wherein the energy buffer comprises a sprung frame acting as force limiter configured to limit or regulate the force applied by the driving unit.
